(19) United States
(12) Patent Application Publication
(10) Pub. No.: US 2013/0076833 A1
(43) Pub. Date: Mar. 28, 2013

(54) USB CONNECTION BETWEEN TWO ELECTRONICS BOARDS

(71) Applicant: Pan Honglin, Singapore (SG)

(72) Inventor: Pan Honglin, Singapore (SG)

(21) Appl. No.: 13/246,056

(22) Filed: Sep. 27, 2011

(51) Int. Cl. B41J 2/14

(52) U.S. Cl. 347/50

(57) ABSTRACT

A printer includes a printhead; a media path; a first electronics board including a first connector for a flexible flat cable; a second electronics board including: a universal serial bus port; a second connector for a flexible flat cable; and a plurality of traces connecting the universal serial bus port to the second connector; and a flexible flat cable connecting the first electronics board to the second electronics board and including a characteristic impedance that meets the characteristic impedance specifications for universal serial bus.

### FIELD OF THE INVENTION

The present invention relates generally to a printing apparatus, and more particularly to electrical interconnection between two electronics boards in a printer, where the electrical interconnection meets Universal Serial Bus (USB) specifications.

### BACKGROUND OF THE INVENTION

Universal Serial Bus (USB) is an industry standard designed to standardize connection of computer peripherals, such as printers, disk drives, keyboards and pointing devices to personal computers, but has been extended to include connection of other electronic devices as well. USB connection is often used for data transfer. As data transfer speed requirements have gone to higher speeds, the USB standard has been revised. The original USB 1.0 specification defined data transfer rates of 1.5 Mbit/sec and 12.0 Mbit/sec. Higher data transfer rates of up to 480 Mbit/sec were enabled with the USB 2.0 specification.

USB cables and connectors include differential signaling, as well as a power line (typically 5 volts) and a ground. Differential signaling is used in order to reduce electromagnetic interference. Conventionally, USB data signals are transmitted on a twisted pair cable with a characteristic impedance of 90 ohms±15%. Other measures taken to reduce electromagnetic interference include using shielded cables having ferrite cores. Twisted pair cables and ferrite cores add cost.

Printers typically have a main electronics board including the controller for the printer functions. In some cases, the main electronics board, being relatively large, is restricted as to its possible locations in a printer, especially for printers having a small form factor or a curved profile. Some printers also include one or more additional smaller electronics boards, such as for input/output (I/O). For example, a USB connection can be required by a printer and is provided on a second electronics board, apart from the main electronics board, in order to position the USB connector at a convenient user-accessible location on the printer. Connection is required between the USB electronics board and the main electronics board.

What is needed is a low cost cabling solution that meets USB specifications (such as USB 2.0 specifications) for providing electrical connection between two electronics boards in a printer.

### SUMMARY OF THE INVENTION

The present invention is directed to overcoming one or more of the problems set forth above. Briefly summarized, according to one aspect of the invention, the invention resides in a printer comprising: a printhead; a media path; a first electronics board including a first connector for a flexible flat cable; a second electronics board including: a universal serial bus port; a second connector for a flexible flat cable; and a plurality of traces connecting the universal serial bus port to the second connector; and a flexible flat cable connecting the first electronics board to the second electronics board and including a characteristic impedance that meets the characteristic impedance specifications for universal serial bus.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic representation of an inkjet printer system;

FIG. 2 is a perspective of a portion of a printhead;

FIG. 3 is a perspective of a portion of a carriage printer;

FIG. 4 is a schematic side view of an exemplary paper path in a carriage printer;

FIG. 5 is a perspective of a multifunction printer having a USB port on a second electronics board connected to a main electronics board using a flexible flat cable;

FIG. 6A is schematic representation of the second electronics board;

FIG. 6B is a schematic representation of a portion of the main electronics board;

FIG. 6C is an enlarged top view of the flexible flat cable; and

FIG. 7 is a cross-sectional view of the flexible flat cable.

### DETAILED DESCRIPTION OF THE INVENTION

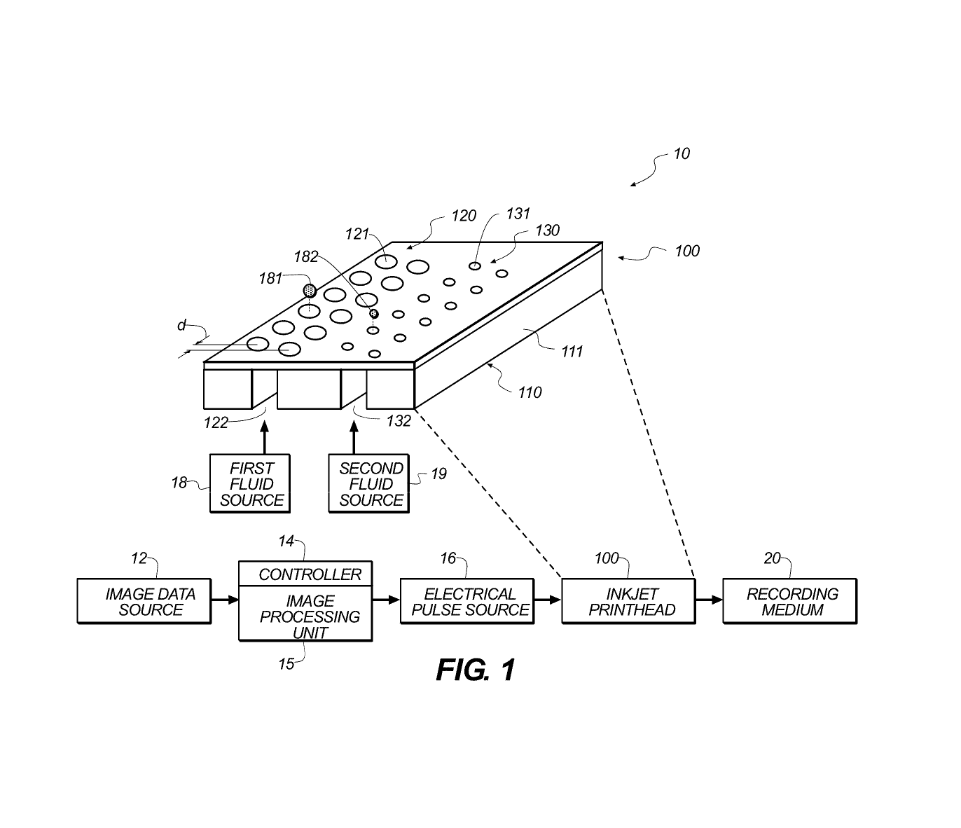

Referring to FIG. 1, a schematic representation of an inkjet printer system 10 is shown, for its usefulness with the present invention and is fully described in U.S. Pat. No. 7,350,902, and is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays 120, 130 has two staggered rows of nozzles, each row having a nozzle density of 600 per inch. The effective nozzle density then in each array is 1200 per inch (i.e. d= 1/1200 inch in FIG. 1). If pixels on a recording medium 20 were sequentially numbered along the paper advance direction, the nozzles 121, 131 from one row of an array 120, 130 would print the odd numbered pixels, while the nozzles 121, 131 from the other row of the array would print the even numbered pixels.

In fluid communication with each nozzle array 120, 130 is a corresponding ink delivery pathway 122, 132. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through a printhead die substrate 111. One or more inkjet printhead die 110 will be included in inkjet printhead 100, but for greater clarity only one inkjet printhead die 110 is shown in FIG. 1. In FIG. 1, a first fluid source 18 supplies ink to first nozzle array 120 via ink delivery pathway 122, and second fluid source 19 supplies ink to second nozzle array 130 via ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132 respectively. Also, in some embodiments, fewer than two or more than two nozzle arrays 120, 130 can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on the recording medium 20.

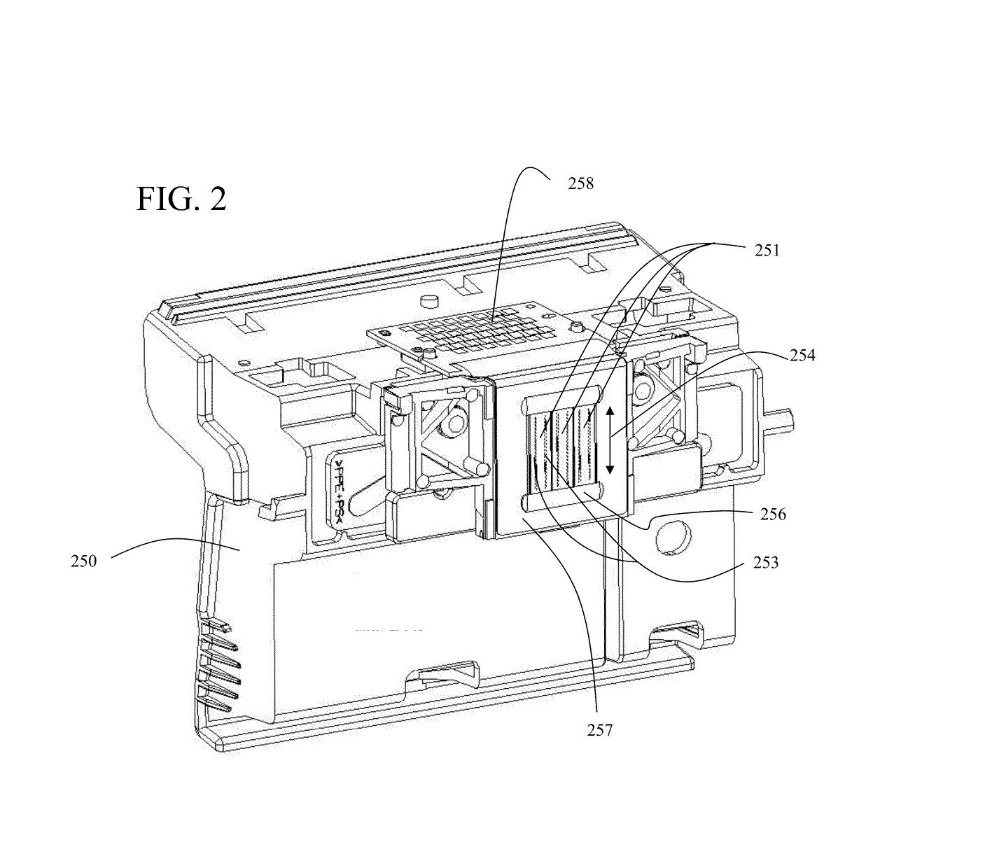

FIG. 2 shows a perspective of a portion of a printhead 250, which is an example of the inkjet printhead 100. Printhead 250 includes three printhead die 251 (similar to printhead die 110 in FIG. 1), each printhead die 251 containing two nozzle arrays 253, so that printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along a nozzle array direction 254, and the length of each nozzle array 253 along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 20. Following the printing of a swath, the recording medium 20 is advanced along a media advance direction that is substantially parallel to nozzle array direction 254.

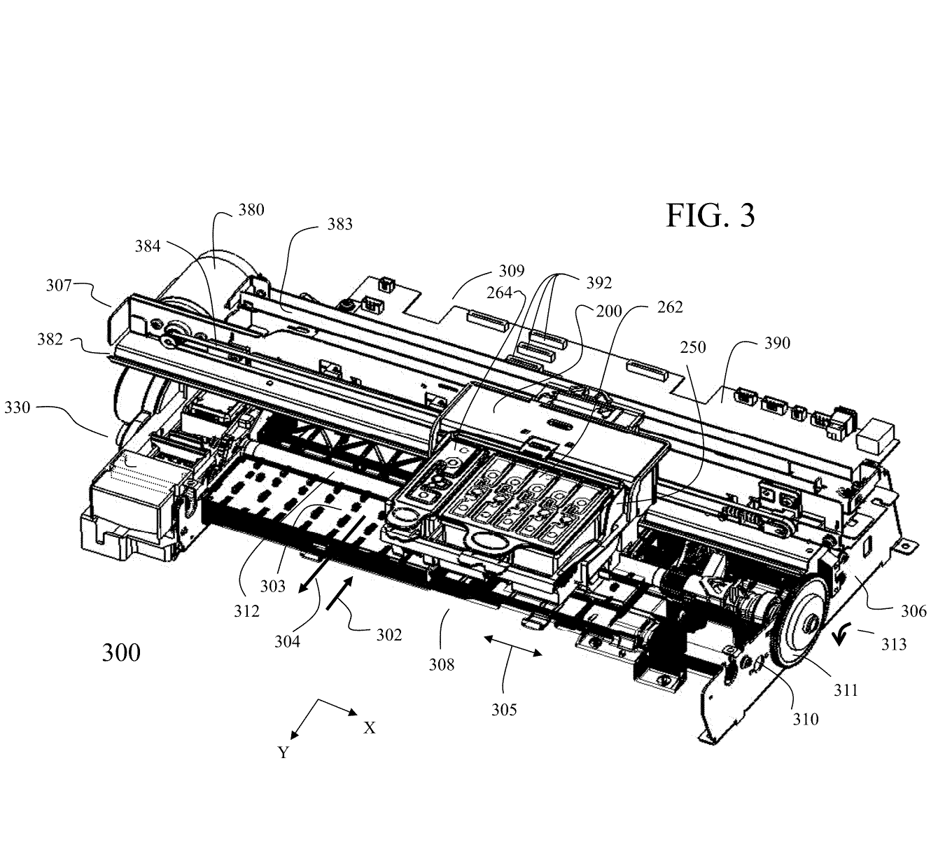

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to connector board 258. When printhead 250 is mounted into a carriage 200 (see FIG. 3), connector board 258 is electrically connected to a connector (not shown) on the carriage 200, so that electrical signals can be transmitted to the printhead die 251.

FIG. 3 shows a portion of a desktop carriage printer. A desktop carriage printer is an example of a stationary printer, which is defined herein as a printer that is intended to be supported by a support structure, such as a desk or a table during operation. Although a stationary printer can be picked up and moved, it is not intended to be handheld or carried during operation.

Some of the parts of the printer have been hidden in the view shown in FIG. 3 so that other parts can be more clearly seen. A printing mechanism 300 has a print region 303 across which carriage 200 is moved back and forth in carriage scan direction 305 along the X axis, between a right side 306 and a left side 307 of printing mechanism 300, while drops are ejected from printhead die 251 (not shown in FIG. 3) on printhead 250 that is mounted on carriage 200. A carriage motor 380 moves a belt 384 to move carriage 200 along a carriage guide rail 382. An encoder sensor (not shown) is mounted on carriage 200 and indicates carriage location relative to an encoder fence 383.

Printhead 250 is mounted in carriage 200, and a multi-chamber ink supply 262 and a single-chamber ink supply 264 are mounted in the printhead 250. The mounting orientation of printhead 250 is rotated relative to the view in FIG. 2, so that the printhead die 251 are located at the bottom side of printhead 250, the droplets of ink being ejected downward onto the recording medium in print region 303 in the view of FIG. 3. Multi-chamber ink supply 262, in this example, contains five ink sources: cyan, magenta, yellow, photo black, and colorless protective fluid; while single-chamber ink supply 264 contains the ink source for text black. Paper or other recording medium (sometimes generically referred to as paper or media herein) is loaded along a paper load entry direction 302 toward the front 308 of printing mechanism 300.

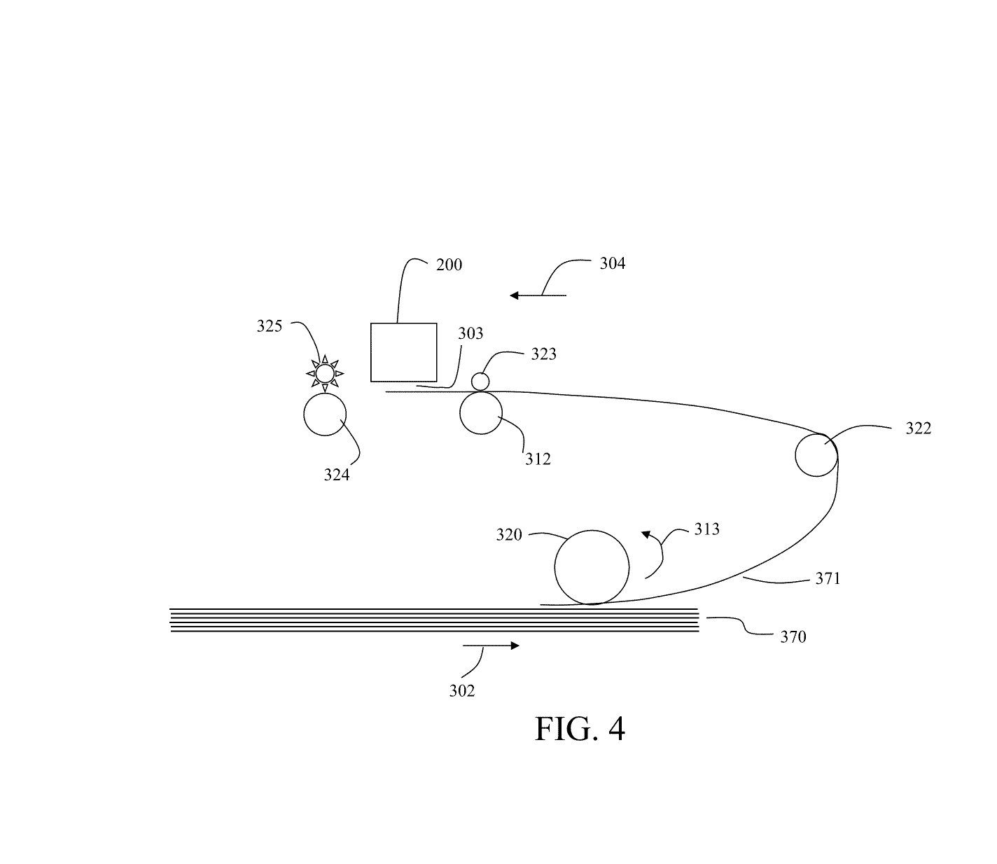

A variety of rollers are used to advance the medium through the printer as shown schematically in the side view of FIG. 4. In this example, a pick-up roller 320 moves a top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along a media advance direction 304 from the rear 309 of the printing mechanism 300 (with reference also to FIG. 3). The paper is then moved by a feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but a hole 310 at the right side of the printing mechanism 306 is where the motor gear (not shown) protrudes through in order to engage feed roller gear 311, as well as the gear for the discharge roller (not shown). For normal paper pick-up and feeding, it is desired that all rollers rotate in a forward rotation direction 313. Toward the left side of the printing mechanism 307, in the example of FIG. 3, is a maintenance station 330.

Toward the rear of the printing mechanism 309, in this example, is located a main electronics board 390, which includes cable connectors 392 for communicating via cables (not shown) to the printhead carriage 200 and from there to the printhead 250. Also on the main electronics board 309 are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

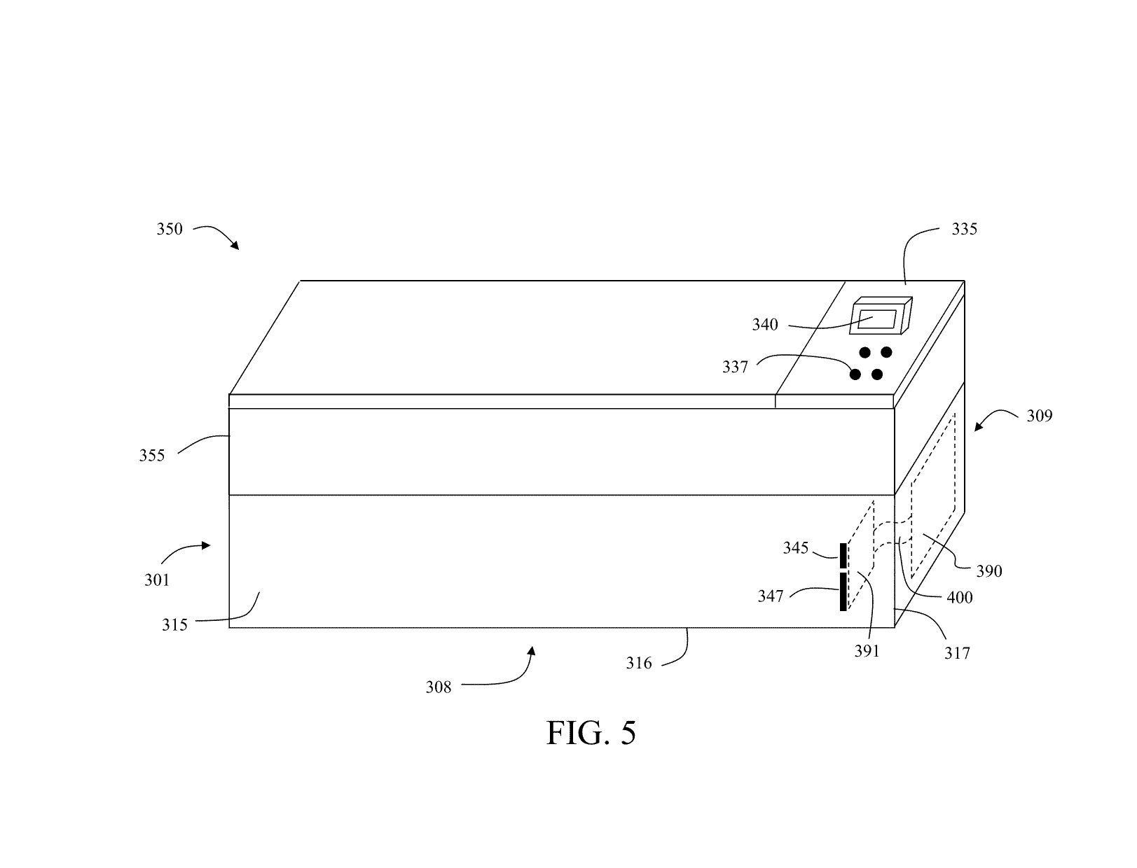

An embodiment of the invention is shown in FIG. 5. A printing apparatus 301 includes a printing mechanism for printing images, such as printing mechanism 300 (FIG. 3), enclosed within a housing 315. In the example of FIG. 5, printing apparatus 301 is part of a multifunction printer 350 that also includes a scanning apparatus 355 for scanning documents or other items, but printing apparatus 301 could alternatively be a single function printer. In the example shown in FIG. 5, printing apparatus 301 includes a control panel 335 having control buttons 337 and a display 340 as part of the user interface. Also provided as part of the user interface are a universal serial bus (USB) port 345 and a connector 347 for a memory device, both of which can be used to provide document or image files to be printed, for example, or can receive document or image files that have been scanned. Main electronics board 390 is located along the right side of printing apparatus 301. USB port 345 and connector 347 are connected directly to a second electronics board 391. Second electronics board 391 is electrically connected to the main electronics board 390 using a flexible flat cable 400 that is configured to have a characteristic impedance that meets USB specifications. For example, for USB 2.0 specifications, the characteristic impedance is required to be 90 ohms±15%, that is, between 76 ohms and 104 ohms. More preferably, the characteristic impedance of flexible flat cable 400 is 90 ohms±10%, that is, between 81 ohms and 99 ohms.

In the example shown in FIG. 5, main electronics board 390 is parallel to second electronics board 391. However, in other examples (not shown) the main electronics board 390 can be oriented parallel to a base 316 of printing apparatus 301, and second electronics board 391 can be oriented perpendicular to base 316, as in FIG. 5. The flexible flat cable 400 can connect two electronics boards having similar orientations or different orientations.

As described in the background, a motivation for having a second electronics board 391 is to enable locating the USB port 345 and the connector 347 for a memory device at a convenient location such as at the front 308 of the printing mechanism 300, while permitting the larger main electronics board 390 to be located at a place where there is more room. For example, for an embodiment (not shown) where a corner 317 of printing apparatus 301 is rounded or beveled in order to provide a more pleasing appearance, main electronics board 390 could fit better along the side and toward the rear 309, while the second electronics board 391 connected to the USB port and connector 347 is located nearer the front 308.

It has been found that the flexible flat cable 400 can be designed to have a characteristic impedance of 90 ohms±10%. It has further been found that the printing apparatus 301 having the second electronics board 391 having the USB port 345 connected to the main electronics board 390 using such a flexible flat cable 400 passes compliance testing meeting the requirements of the USB 2.0 specification, including high speed data transfer and signal quality. Satisfactory performance by such a flexible flat cable 400 can be aided if the cable is not as long as the five meter maximum length permitted by the USB specification. For connecting two electronics boards 390, 391 in a printing apparatus 301, cable lengths (from an array of contacts at a first end to a corresponding array of contacts at a second end) is typically less than 1 meter, and can be less than 30 centimeters.

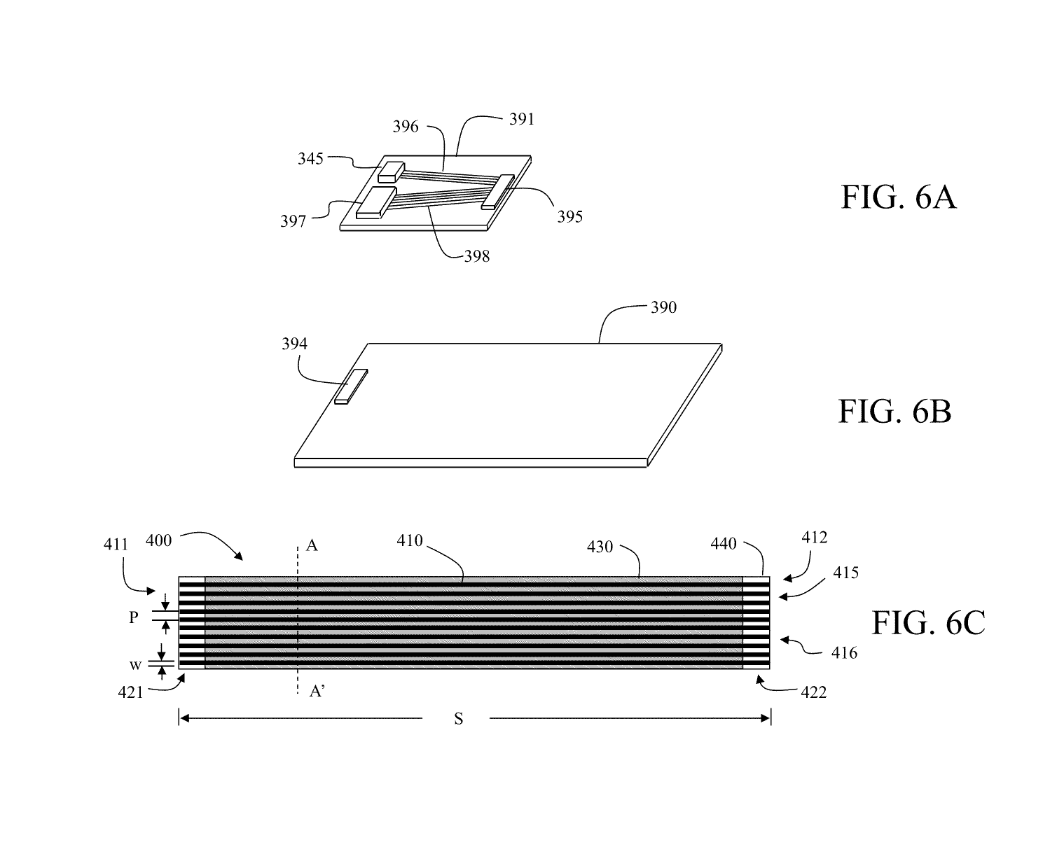

FIG. 6A shows a schematic representation of the second electronics board 391, FIG. 6B shows a schematic representation of the main electronics board 390, and FIG. 6C shows an enlarged top view (not to scale) of the flexible flat cable 400 for connecting the second electronics board 391 to the main electronics board 390. Main electronics board 390 includes a first connector 394 for flexible flat cable 400. Other components of main electronics board 390 are not shown. Second electronics board 391 includes the USB port 347, a second connector 395 for flexible flat cable 400, and a plurality of traces 396 (i.e. conductive pathways) connecting USB port 345 to the second connector 395 for flexible flat cable 400. As shown in FIG. 6A, the plurality of traces 396 includes four traces (for Data −, Data +, power and ground). Additionally, in the example shown in FIG. 6A, second electronics board 391 includes a third connector 397 and a second plurality of traces 398 connecting third connector 397 to the second connector 395 for flexible flat cable 400. Third connector 397 can be a second USB port, or it can be a connector 347 for a memory device as shown in FIG. 5. Alternatively, second plurality of traces 398 can connect other circuitry (such as Wi-Fi circuitry) on second electronics board 391 to second connector 395 for flexible flat cable 400. Because USB connection only requires four leads and it is straightforward and inexpensive to provide flexible flat cables and corresponding connectors with more than four leads, using flexible flat cable 400 to make electrical connection between second electronics board 391 and main electronics board 390 for other functions in addition to USB port 345 can provide cost benefits. In such examples a first group 415 of leads 410 of flexible flat cable 400 are connected to USB port 345 via plurality of traces 396, and a second group 416 of leads 410 are connected to third connector 397 via plurality of traces 398.

In the example shown in FIG. 6C, flexible flat cable 400 includes ten leads 410, but in other examples, flexible flat cable 400 can have more than ten or fewer than ten leads 410. The leads 410 extend from a first array of contacts 421 at a first end 411 and connect to a second array of contacts 422 at a second end 412 of the flexible flat cable 400. Flexible flat cable 400 has a length S between first end 411 and second end 412. Leads 410 are affixed to a first flexible insulating film 430 and also to a second insulating film 440. First insulating film 430 does not cover leads 410 near first end 411 and second end 412 where the first array of contacts 421 and second array of contacts 422 are exposed, but a second insulating film 440 extends below the contacts 421 and 422 to provide support. In some embodiments, a stiffener (not shown) is provided at the first end 411 and the second end 412 in order facilitate insertion of flexible flat cable 400 into first connector 394 and second connector 395. The parallel leads 410 have a width w and a center to center pitch P.

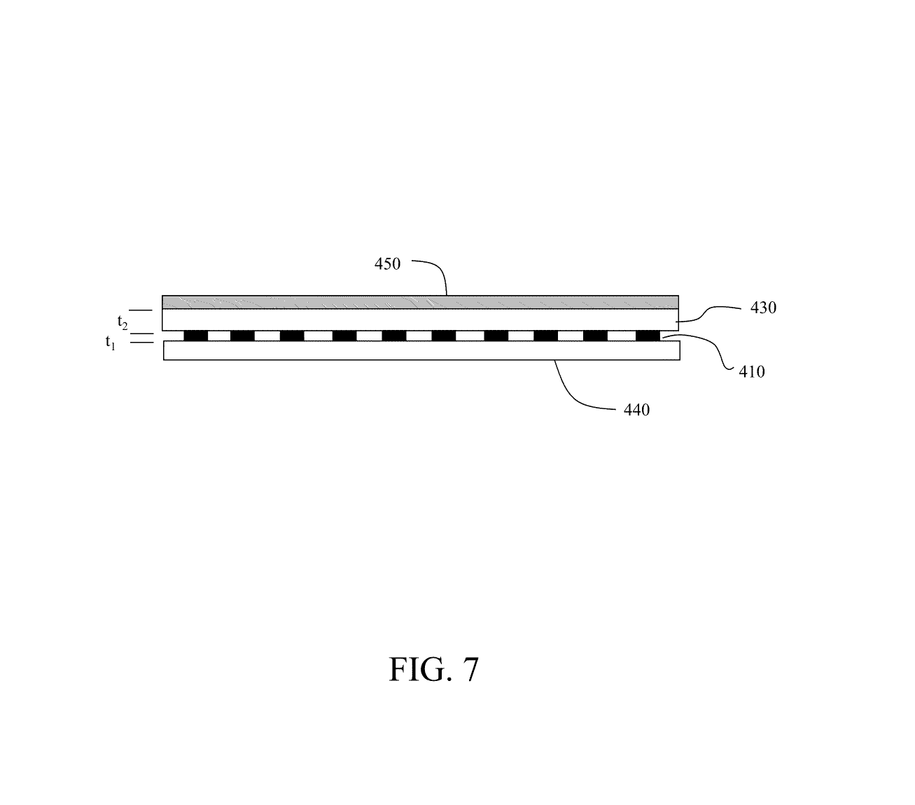

FIG. 7 shows a cross-sectional view of flexible flat cable 400 at A-A′ of FIG. 6C and provides additional details. In particular, a first insulating film 430 includes a first side and a second side, where a conductive layer 450 is affixed to the first side of first insulating film 430, and leads 410 are affixed to the second side of the first insulating film 430. Conductive layer 450 provides electromagnetic shielding. Leads 410 are between the first insulating film 430 and the second insulating film 440.

At high frequency (which is the region of interest for high speed data transfer for USB) the characteristic impedance is approximately equal to (L/C)^{1/2}, where L is the inductance and C is the capacitance. The capacitance of flexible flat cable 400 depends at least in part upon the dielectric constant and the thickness of first insulating film 430. First insulating film 430 can be made of the same material as second insulating film 440, or it can be made of a different material. In a specific example, it was found that a flexible flat cable having a first insulating film 430 made of Mylar and having a thickness t₂ of 0.225 mm, a characteristic impedance of 85 to 88 ohms was provided, thus satisfying the USB specification of 90 ohms±10%. More generically, Mylar is biaxially-oriented polyethylene terephthalate, which is a polyester film made from stretched polyethylene terephthalate. Other details of this exemplary flat flexible cable 400 include a lead width w of 0.5 mm, a pitch P of 1 mm, and a lead thickness t₁ of 0.035 mm. As described above, it was found that a printing apparatus 301 having a second electronics board 391 having a USB port 345 connected to the main electronics board 390 using such a flexible flat cable 400 passes compliance testing meeting the requirements of the USB 2.0 specification, including high speed data transfer and signal quality.

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
250 Printhead
251 Printhead die
253 Nozzle array
254 Nozzle array direction
256 Encapsulant
257 Flex circuit
258 Connector board
262 Multi-chamber ink supply
264 Single-chamber ink supply
300 Printing mechanism
301 Printing apparatus
302 Paper load entry direction
303 Print region
304 Media advance direction
305 Carriage scan direction
306 Right side of printing mechanism
307 Left side of printing mechanism
308 Front of printing mechanism
309 Rear of printing mechanism
310 Hole (for paper advance motor drive gear)
311 Feed roller gear
312 Feed roller
313 Forward rotation direction (of feed roller)
315 Housing
316 Base
317 Corner
320 Pick-up roller
322 Turn roller
323 Idler roller
324 Discharge roller
325 Star wheel(s)
330 Maintenance station
335 Control panel
337 Control button
340 Display
345 USB port
347 Connector (for memory device)
350 Multifunction printer
355 Scanning apparatus
370 Stack of media
371 Top piece of medium
380 Carriage motor
382 Carriage guide rail
383 Encoder fence
384 Belt
390 Main electronics board
391 Second electronics board
392 Cable connectors (for carriage)
394 First connector (for flexible flat cable)
395 Second connector (for flexible flat cable)
396 Traces (connecting USB port to second connector)
397 Third connector
398 Traces (connecting third connector to second connector)
400 Flexible flat cable
410 Lead
411 First end
412 Second end
415 First group
416 Second group
421 First array of contacts
422 Second array of contacts
430 First insulating film
440 Second insulating film.
450 Conductive layer

1. A printer comprising:
a printhead;
a media path;
a first electronics board including a first connector for a flexible flat cable;
a second electronics board including:
a universal serial bus port;
a second connector for a flexible flat cable; and
a plurality of traces connecting the universal serial bus port to the second connector; and
a flexible flat cable connecting the first electronics board to the second electronics board and including a characteristic impedance that meets the characteristic impedance specifications for universal serial bus.

2. The printer of claim 1, wherein the characteristic impedance is between 76 ohms and 104 ohms.

3. The printer of claim 2, wherein the characteristic impedance is between 81 ohms and 99 ohms.

4. The printer of claim 1, the flexible flat cable including a first end including a first array of contacts and a second end including a second array of contacts connected to the first array of contacts, wherein a length between the first end and the second end is less than one meter.

5. The printer of claim 4, wherein the length between the first end and the second end is less than 30 centimeters.

6. The printer of claim 1, wherein the flexible flat cable includes:
a first insulator including a first side and a second side;
a conductive layer affixed to the first side of the first insulator;
an array of parallel leads affixed to the second side of the first dielectric; and
a second insulator, wherein the array of parallel leads is disposed between the first insulator and the second insulator.

7. The printer of claim 6, wherein the first insulator is different from the second insulator.

8. The printer of claim 6, wherein the first insulator is Mylar.

9. The printer of claim 1, the second electronics board further including a third connector, and the flexible flat cable further including:
a first plurality of leads connected to the universal serial bus port; and
a second plurality of leads connected to the third connector.

10. The printer of claim 9, wherein the third connector is not a universal serial bus port.

11. The printer according to claim 10, wherein the third connector is a memory device connector.

12. The printer of claim 1 further comprising a scanning apparatus.
